(19) United States
(12) Patent Application Publication
(10) Pub. No.: US 2009/0146554 A1
(43) Pub. Date: Jun. 11, 2009

(54) ORGANIC LIGHT EMITTING DIODE AND ORGANIC ELECTRO-LUMINESCENCE DISPLAY DEVICE THEREWITH

(76) Inventors: Kwang Yeon Lee, Gumi-si (KR); Sung Hoon Choi, Bucheon-si (KR); Hee Seok Yang, Hwaseong-si (KR); Kyu Il Han, Suwon-si (KR)

Correspondence Address: BRINKS HOFER GILSON & LIONE, P.O. BOX 10395, CHICAGO, IL, 60610, US

(21) Appl. No.: 12/269,228

(22) Filed: Nov. 12, 2008

(30) Foreign Application Priority Data
Dec. 7, 2007 (KR) 10-2007-0126901

(51) Int. Cl. H01J 1/63

(52) U.S. Cl. 313/504; 257/40

(57) ABSTRACT

An organic light emitting diode has improved light emitting efficiency and life span. The organic light emitting diode includes an electron transfer layer formed by mixing Liq and organic substance of predetermined chemical formula at a predetermined ratio. In accordance therewith, a driving voltage of the organic light emitting diode is lowered. As a result, the light emitting efficiency and the life span of the organic light emitting diode can be improved.

### RELATED APPLICATIONS

This application claims priority under 35 U.S.C. 119 to Korean Patent Application No. 10-2007-00126901, filed on Dec. 07, 2007, which is hereby incorporated by reference in its entirety.

### BACKGROUND

1. Field of the Disclosure

This disclosure relates to an organic light emitting diode, and more particularly, to an organic light emitting diode having improved features and an organic electro-luminescence display device including the same.

2. Description of the Related art

As the information society spreads, flat display devices capable of displaying information have been widely developed. These flat display devices include liquid crystal display (LCD) device, organic electro-luminescence display devices, plasma display devices, and field emission display devices. Among the above flat display devices, the organic electro-luminescence display devices are active devices which generate light by themselves and do not need backlight units, such as those required for LCD devices. As a result, the organic electro-luminescence display devices can be manufactured to be light and small, can consume less power, and can provide a full color scheme. Also, organic electro-luminescence display devices have a simple structure because a backlight unit, color filter layer, and polarization panel, which included in LCD device are not needed.

Such advantages have accelerated the development of organic electro-luminescence display devices. As a result, compact organic electro-luminescence display devices are already being released to the market.

FIG. 1 is a cross-sectional view of a general organic electro-luminescence display device. Referring to FIG. 1, an organic electro-luminescence display device includes first and second substrates 10 and 70. The first and second substrates 10 and 70 are closely combined using a sealant 80 along the inner edges of the first and second substrates 10 and 70 to prevent the intrusion of external moisture.

The first substrate 10 is provided with driving elements 20 and organic light emitting diodes 60. The driving elements 20 include a plurality of gate lines and a plurality of data lines arranged to define each pixel and a plurality of thin film transistors (TFTs) electrically connected to the gate lines and the data lines, respectively.

The organic light emitting diode 60 includes a plurality of first electrodes 30 arranged at each pixel and electrically connected to each of the TFTs, a second electrode 50 commonly arranged to each pixel, and a plurality of organic light emitting units 40 formed between the first and second electrodes 30 and 50. Each of the first electrodes 30 is electrically connected to each of the TFTs.

Each of the organic light emitting units 40 includes a hole injection layer 41, a hole transfer layer 43, a light emitting layer 45, an electron transfer layer 47, and an electron injection layer 49, which are sequentially deposited, as shown in FIG. 2. While the hole injection layer 41 is arranged in contact with the first electrode 30, the electron injection layer 49 is arranged in contact with the second electrode 50.

The hole injection layer 41 and the hole transfer layer 43 help electric holes to be easily injected into the light emitting layer 45. The electron injection layer 49 and the electron transfer layer 45 help electrons to be easily injected into the light emitting layer 45. The respective layers are formed of an organic substance.

However, since these layers are not optimized, the holes and electrons are not easily injected in the light emitting layer 45. Thus, a light emitting efficiency of the light emitting layer 45 is not improved and the initial life span of the organic light emitting diode is deteriorated. Furthermore, since a higher voltage needs to be applied for the same light emitting efficiency, a drive voltage is increased.

### BRIEF SUMMARY

An organic light emitting diode includes a first electrode, a second electrode, and an organic light emitting unit formed between the first and second electrodes and comprising an electron transfer layer, wherein the electron transfer layer is formed of a mixture of an organic substance and Liq.

An organic electro-luminescence display device according to another general aspect of the present embodiment includes a first substrate comprising driving elements, a second substrate combined to the first substrate, and an organic light emitting diodes formed on any of the first and second substrates. Each of the organic light emitting diodes includes a first electrode, a second electrode, and an organic light emitting unit formed between the first and second electrodes and including an electron transfer layer. The electron transfer layer is formed of a mixture of an organic substance and Liq.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the embodiments and are incorporated in and constitute a part of this application, illustrate embodiment(s) of the invention and together with the description serve to explain the disclosure. In the drawings:

FIG. 1 is a cross-sectional view of a general organic electro-luminescence display device;

FIG. 2 is a conceptual diagram of the organic light emitting diode of FIG. 1;

FIG. 3 is a conceptual diagram of an organic light emitting diode according to an embodiment of the present embodiment; and

FIG. 4 is a graph showing the light span characteristic of the organic light emitting diode of FIG. 3.

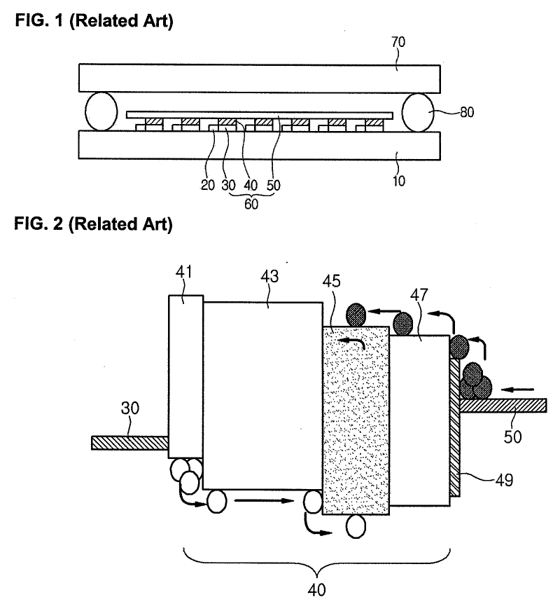

### DETAILED DESCRIPTION OF THE DRAWINGS AND THE PRESENTLY PREFERRED EMBODIMENTS

Reference will now be made in detail to the embodiments of the present disclosure, examples of which are illustrated in the accompanying drawings. Wherever possible, the same reference numbers will be used throughout the drawings to refer to the same or like parts.

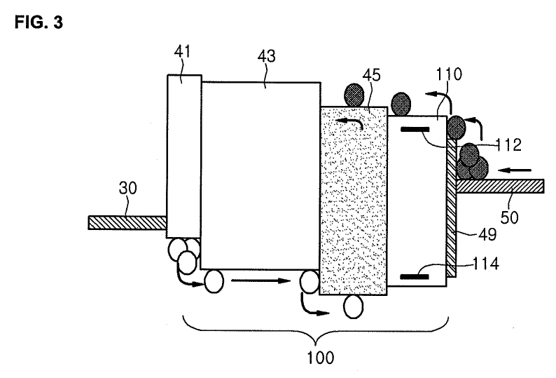

FIG. 3 is a conceptual diagram of an organic light emitting diode according to an embodiment of the present disclosure. Referring to FIG. 3, an organic light emitting diode according to the present embodiment includes the first electrode 30, the second electrode 50, and an organic light emitting unit 100 formed between the first and second electrodes 30 and 50. In the organic light emitting unit 100, the hole injection layer 41, the hole transfer layer 43, the light emitting layer 45, an electron transfer layer 110, and the electron injection layer 49 are sequentially deposited. The hole injection layer 41 is arranged in contact with the first electrode 30, while the electron injection layer 49 is arranged in contact with the second electrode 50.

The first electrode 30 may be formed of a transparent conductive material, for example, indium-tin-oxide (ITO) or indium-zinc-oxide (IZO). The second electrode 50 may be formed of an opaque conductive material such as aluminum (Al), chromium (Cr), or gold (Ag).

The hole injection layer 41 needs to inject many more holes in the hole injection layer 41. The hole transfer layer 43 needs to transfer many more of the holes injected in the hole injection layer 41 to the light emitting layer 45. The electron injection layer 49 needs to inject many more electrons in the electron injection layer 49. The electron transfer layer 110 need to transfer many more of the electrons injected in the electron injection layer 49 to the light emitting layer 45.

The light emitting layer 45 emits a red, green, or blue light by the recombination of the electrons and the holes. Each of the hole injection layer 41, the hole transfer layer, 43, the light emitting layer 45, the electron transfer layer 110, and the electron injection layer 49 may be formed of organic substances. A dopant may be added to the light emitting layer 45, if necessary.

In the present embodiment, the electron transfer layer 110 may be formed by mixing Liq and an organic substance having a compound represented by Formula 1. The compound may be an imidazole derivative.

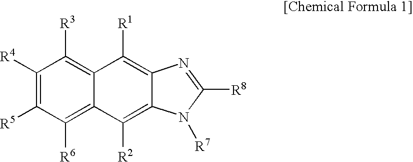

In Chemical Formula 1, R1-R6 are independently or simultaneously selected from a group consisting of hydrogen, a substituted or unsubstituted alkyl group, a substituted or unsubstituted alkoxy group, a substituted or unsubstituted alkenyl group, a substituted or unsubstituted aryl group, a substituted or unsubstituted aryl amine group, a substituted or unsubstituted heterocyclic group, a substituted or unsubstituted aliphatic cyclic group, a substituted or unsubstituted silicon group, a substituted or unsubstituted boron group, an amino group, a nitrile group, a nitro group, a halogen group, an amide group, and an ester group. R7 is selected from a group consisting of a substituted or unsubstituted alkyl group, a substituted or unsubstituted aryl group, a substituted or unsubstituted heterocyclic group, a substituted or unsubstituted aliphatic cyclic group, and a substituted or unsubstituted silicon group. R8 is selected from a group consisting of a substituted or unsubstituted alkyl group, a substituted or unsubstituted aryl group, and a substituted or unsubstituted heterocyclic group.

The compound of the present embodiment will now be described in detail. The compound of Chemical Formula 1 is a new compound and the substituted group thereof will also be described in detail.

The alkyl group of R1-R8 of Chemical Formula 1 may have a carbon number of 1-30. The alkoxy group and the alkenyl group of R1-R6 of Chemical Formula 1 may have a carbon number of 1-30. Although the aryl group of R1-R8 of Chemical Formula 1 may be a phenyl group, a naphthyl group, an antracenyl group, a biphenyl group, a pyrenyl group, or a perylenyl group, the present embodiment is not limited thereto. Although the aryl amine group of R1-R6 of Chemical Formula 1 may be a diphenyl amine group, a phenyl naphthyl amine group, a ditolyl amine group, a phenyl tolyl amine group, a carbazolyl group, or a triphenyl amine group, the present embodiment is not limited thereto. Although the heterocyclic group of R1-R8 of Chemical Formula 1 may be a pyridyl group, a bipyridyl group, an acridinyl group, a thienyl group, an imidazolyl group, an oxazolyl group, a thiazolyl group, or a quinolyl group, the present embodiment is not limited thereto. Although the halogen group of R1-R6 of Chemical Formula 1 may be fluorine, chlorine, bromine, or iodine, the present embodiment is not limited thereto.

In the present embodiment, R7 may be selected from a group consisting of a substituted or unsubstituted alkyl group, a substituted or unsubstituted cycloalkyl group, a substituted or unsubstituted aryl group, and a substituted or unsubstituted heteroaryl group. The alkyl group may include a methyl group, an ethyl group, a propyl group, an isopropyl group, a butyl group, a tertiary butyl group, a phenethyl group, a hexyl group, and a heptyl group. The cycloalkyl group includes a cyclophenethyl group, and a cyclohexyl group. The alkyl group or the cycloalkyl group preferably does not cause a steric hindrance of the carbon number of 1-30, but the present embodiment is not limited thereto. The aryl group may be a phenyl group, a biphenyl group, or a naphthyl group. Also, the aryl group may be a heteroaryl group such as a pyridyl group, a bipyridyl group, a quinolyl group, or an isoquinolyl group.

In the present embodiment, when R1-R8 of Chemical Formula 1 are substituted by other substitution groups, there may be one or more substitution groups that are selected from a group consisting of —CN, a nitro group, a carbonyl group, an amide group, an alkyl group, an alkenyl group, an aryl group, an aryl amine group, a heterocyclic group, an aliphatic cyclic group, —BRR′, and —SiRR′R″. R, R′, and R″ are identical to or different from one another and independently selected from an alkyl group of C1-C20, an aryl group of C6-C20, or an aryl group of C6-C20 which is substituted by the alkyl group of C1-C20. The alkyl group may be C1-C20 and the alkenyl group may be C2-C20. The aryl group may be C6-C20 and the aryl amine group may be an amine group substituted by the aryl group of C6-C20. In the compound of Chemical Formula 1 having the above substitution groups, the property of the compound does not change according to the above-described core structure based on the type of the substitution group. When R1-R8 of Chemical Formula 1 are substituted by other substitution groups, the present embodiment does not intend a case in which the substitution group is OH.

In Chemical Formula 1, R1 and R2 are not hydrogen at the same time and are selected from a group consisting of hydrogen, a substituted or unsubstituted aryl group, a substituted or unsubstituted alkenyl group, a substituted or unsubstituted aryl amine group, and a substituted or unsubstituted heterocyclic group. R3-R6 are selected from a group consisting of hydrogen, a substituted or unsubstituted aryl group, a substituted or unsubstituted aryl amine group, and a substituted or unsubstituted heterocyclic group. R7 is selected from a group consisting of an alkyl group, a phenyl group, a biphenyl group, and a naphthyl group. R8 is selected from a group consisting of a substituted or unsubstituted alkyl group, a substituted or unsubstituted aryl group, and a substituted or unsubstituted heterocyclic group.

In Chemical Formula 1, R1, R2, and R8 is selected from a group consisting of an aryl group and a heterocyclic group, R3-R6 is hydrogen, and R7 is selected from a group consisting of an alkyl group and an aryl group. Liq has a conduction band of 5.58 eV and a balance band of 3.153 eV. Liq has an effect of lowering an electric potential barrier.

As shown in FIG. 3, a balance band 112 of the electron transfer layer 110 including Liq may be set to 3.153 eV and a conduction band 114 may be set to 5.58 eV. This may lower the electric potential barrier of the balance band 112 compared to a conventional electron transfer layer so that more of the electrons of the electron injection layer 49 can be easily transferred to the light emitting layer 45.

Thus, in the present embodiment, through a process of forming the electron transfer layer 110 by mixing Liq and the organic substance including the imidazole derivative indicated by Chemical Formula 1, the electric potential barrier is lowered so that more electrons can be easily injected in the light emitting layer 45. Accordingly, the light emitting efficiency of the light emitting layer 45 is improved. Also, since the electric potential barrier is lowered, the organic light emitting diode can be driven at a lower voltage. Furthermore, since the electron transfer layer 110 of the present embodiment improves the characteristic of a boundary surface with the electron injection layer 49 so that the characteristic of the electron injection and an initial light emitting life span of the organic light emitting diode are improved.

In the present embodiment, as shown in Table 1, experiments have been performed for each case in which only an organic substance including the imidazole derivative indicated by Chemical Formula 1 is used, and a mixture of Liq and the organic substance including the imidazole derivative indicated by Chemical Formula 1 is used at different mixing ratios. The characteristics of organic light emitting diodes, each having the electron transfer layer and formed of each of samples, were measured.

TABLE 1

| | | Driving | Luminous | Light | | | Life |
|---|---|---|---|---|---|---|---|
| | Mixture | Voltage | Intensity | Efficiency | Color | Color | Span |
| Sample | Ratio | (V) | (cd/A) | (lm/w) | (CIE_x) | (CIE_y) | (hr) |
| Compound of | | 4.6 | 5.9 | 4.0 | 0.137 | 0.202 | 0.65 |
| Chemical Formula 1 | | | | | | | |
| only | | | | | | | |
| Compound of | 3:1 | 4.1 | 6.7 | 5.2 | 0.137 | 0.201 | 7.5 |
| Chemical Formula | | | | | | | |
| 1 + Liq | | | | | | | |
| Compound of | 1:1 | 3.8 | 7.7 | 6.3 | 0.137 | 0.203 | 6.25 |
| Chemical Formula | | | | | | | |
| 1 + Liq | | | | | | | |
| Compound of | 1:3 | 3.9 | 8.2 | 6.6 | 0.137 | 0.205 | 10.2 |
| Chemical Formula | | | | | | | |
| 1 + Liq | | | | | | | |

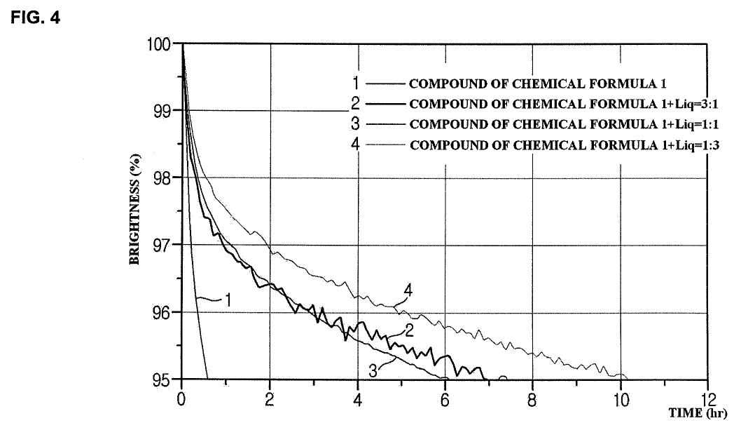

As shown in Table 1, compared to the electron transfer layer formed of the compound of Chemical Formula 1, the driving voltage is decreased, the luminous intensity and the light efficiency are increased, and the life span is extended in all electron transfer layers in which mixture ratios of the compound of Chemical Formula 1 and Liq are 3:1, 1:1, and 1:3. In particular, the driving voltage is at its lowest when the mixture ratio of the compound of Chemical Formula 1 and Liq is 1:1. The luminous intensity, light efficiency, and life span are the highest when the mixture ratio of the compound of Chemical Formula 1 and Liq is 1:3. Thus, in the present embodiment, when the mixture ratio of the compound of Chemical Formula 1 and Liq is in a range of 30-300%, the driving voltage, luminous intensity, light efficiency, and life span are all superior. As shown in FIG. 4, compared to the electron transfer layer indicated by line 1, which is formed of the compound of Chemical Formula 1, the initial life span is generally improved in the electron transfer layers indicated by lines 2, 3, and 4, in which the mixture ratios of the compound of Chemical Formula 1 and Liq are, respectively, 3:1,1:1, and 1:3.

In the manufacturing process of an organic light emitting diode, the first electrode 30 is firstly formed by patterning. Then, the hole injection layer 41, the hole transfer layer 43, the light emitting layer 45, the electron transfer layer 110, and the electron injection layer 49 are sequentially deposited on the first electrode 30 in a deposition process using a hard mask (not shown).

The electron transfer layer 110 may be formed of a mixture of Liq and the compound of Chemical Formula 1 in the deposition process using the hard mask. The mixture ratio of Liq may be within a range of 30-300% of the compound of Chemical Formula 1. The second electrode 50 is formed on the electron injection layer 49 by patterning. The driving element is formed with the organic light emitting diode so that an organic electro-luminescence display device can be manufactured.

For example, the driving element and the organic electro-luminescence display device can be formed on the first substrate. Alternatively, the driving element can be formed on the first substrate while the organic light emitting diode can be formed on the second substrate. The first and second substrates can be combined using a sealant so that the organic electro-luminescence display device.

As described above, in the organic light emitting diode and the organic electro-luminescence display device according to the present embodiment, since the electron transfer layer is formed by mixing Liq and the organic substance having a predetermined chemical formula at a predetermined ratio, the driving voltage is lowered and the light emitting efficiency and the life span can be improved.

It will be apparent to those skilled in the art that various modifications and variations can be made in the present embodiment. Thus, it is intended that the present embodiment cover the modifications and variations of this invention provided they come within the scope of the appended claims and their equivalents.

1. An organic light emitting diode comprising:
a first electrode;
a second electrode; and
an organic light emitting unit, between the first and second electrodes, including an electron transfer layer, which is formed of a mixture of an organic substance and Liq.

2. The organic light emitting diode claimed as claim 1, wherein the organic substance is a compound indicated by Chemical Formula 1, 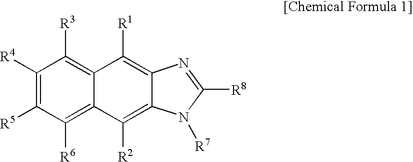
where, in the Chemical Formula 1, R1-R6 are independently or simultaneously selected from a group consisting of hydrogen, a substituted or unsubstituted alkyl group, a substituted or unsubstituted alkoxy group, a substituted or unsubstituted alkenyl group, a substituted or unsubstituted aryl group, a substituted or unsubstituted aryl amine group, a substituted or unsubstituted heterocyclic group, a substituted or unsubstituted aliphatic cyclic group, a substituted or unsubstituted silicon group, a substituted or unsubstituted boron group, an amino group, a nitrile group, a nitro group, a halogen group, an amide group, and an ester group, R7 is selected from a group consisting of a substituted or unsubstituted alkyl group, a substituted or unsubstituted aryl group, a substituted or unsubstituted heterocyclic group, a substituted or unsubstituted aliphatic cyclic group, and a substituted or unsubstituted silicon group, and R8 is selected from a group consisting of a substituted or unsubstituted alkyl group, a substituted or unsubstituted aryl group, and a substituted or unsubstituted heterocyclic group.

3. The organic light emitting diode claimed as claim 2, wherein the R1 and the R2 are not hydrogen at the same time and are selected from a group consisting of hydrogen, a substituted or unsubstituted aryl group, a substituted or unsubstituted alkenyl group, a substituted or unsubstituted aryl amine group, and a substituted or unsubstituted heterocyclic group, the R3-R6 are selected from a group consisting of hydrogen, a substituted or unsubstituted aryl group, a substituted or unsubstituted aryl amine group, and a substituted or unsubstituted heterocyclic group, the R7 is selected from a group consisting of an alkyl group, a phenyl group, a biphenyl group, and a naphthyl group, and the R8 is selected from a group consisting of a substituted or unsubstituted alkyl group, a substituted or unsubstituted aryl group, and a substituted or unsubstituted heterocyclic group.

4. The organic light emitting diode claimed as claim 2, wherein the compound is an imidazole derivative.

5. The organic light emitting diode claimed as claim 2, wherein the mixing ratio of Liq is within a range of 30-300% of the compound of the Chemical Formula 1.

6. An organic electro-luminescence display device comprising:
a first substrate comprising a driving element;
a second substrate combined to the first substrate; and
an organic light emitting diode, on any one of the first and second substrates, including:
a first electrode;
a second electrode; and
an organic light emitting unit, between the first and second electrodes, including an electron transfer layer which is formed of a mixture of an organic substance and Liq.

7. The organic electro-luminescence display device claimed as claim 6, wherein the organic substance is a compound indicated by Chemical Formula 1, 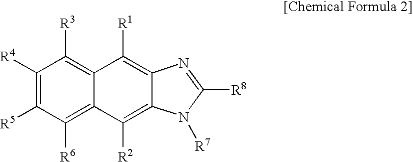
where, in the Chemical Formula 1, R1-R6 are independently or simultaneously selected from a group consisting of hydrogen, a substituted or unsubstituted alkyl group, a substituted or unsubstituted alkoxy group, a substituted or unsubstituted alkenyl group, a substituted or unsubstituted aryl group, a substituted or unsubstituted aryl amine group, a substituted or unsubstituted heterocyclic group, a substituted or unsubstituted aliphatic cyclic group, a substituted or unsubstituted silicon group, a substituted or unsubstituted boron group, an amino group, a nitrile group, a nitro group, a halogen group, an amide group, and an ester group, R7 is selected from a group consisting of a substituted or unsubstituted alkyl group, a substituted or unsubstituted aryl group, a substituted or unsubstituted heterocyclic group, a substituted or unsubstituted aliphatic cyclic group, and a substituted or unsubstituted silicon group, and R8 is selected from a group consisting of a substituted or unsubstituted alkyl group, a substituted or unsubstituted aryl group, and a substituted or unsubstituted heterocyclic group.

8. The organic electro-luminescence display device claimed as claim 7, wherein the compound is an imidazole derivative.

9. The organic electro-luminescence display device claimed as claim 7, wherein the mixing ratio of liq is within a range of 30-300% of the compound of the chemical formula 1.
